(19) United States
(12) Patent Application Publication
(10) Pub. No.: US 2020/0398466 A1
(43) Pub. Date: Dec. 24, 2020

(54) METHOD FOR MANUFACTURING BASE PLATE FOR KEYBOARD

(71) Applicant: SUNREX TECHNOLOGY CORP., Taichung City (TW)

(72) Inventor: Shih-Pin LIN, Taichung City (TW)

(21) Appl. No.: 16/565,011

(22) Filed: Sep. 9, 2019

(30) Foreign Application Priority Data
Jun. 18, 2019 (TW) 108121085

(51) Int. Cl. B29C 45/14; B29B 13/00

(52) U.S. Cl. CPC B29C 45/14311; B29K 2669/00; B29C 2045/14327; B29B 13/00

(57) ABSTRACT

A method for manufacturing a base plate for a keyboard includes the steps of: a) providing a mold assembly including a female mold and a male mold, b) preparing a composite laminate which includes a carbon fiber layer and a thermoplastic resin layer, and which is formed with a plurality of positioning holes, c) disposing the composite laminate in the female mold, and combining the female and male molds, and d) injecting a plastic material to form positioning blocks which binds to the thermoplastic resin layer and integrates with the composite laminate to form the base plate.

### CROSS-REFERENCE TO RELATED APPLICATION

This application claims priority of Taiwanese Invention Patent Application No. 108121085, filed on Jun. 18, 2019.

### FIELD

This disclosure relates to a method for manufacturing a base plate, and more particularly to a method for manufacturing a base plate for a keyboard.

### BACKGROUND

Referring to FIG. 1, keyboard includes a conventional base plate 11 and a key unit 12. The conventional base plate 11 includes a plate body 111 made of aluminum, and a plurality of plastic positioning blocks 112 installed on the plate body 111. The key unit 12 includes a plurality of key assemblies 121, each of which is detachably retained by corresponding ones of the plastic positioning blocks 112.

Referring to FIGS. 1 and 2, in an existing process for manufacturing the conventional base plate 11, it is necessary to punch an aluminum plate to form a plurality of engaging structures 113 at pre-determined locations on the aluminum plate to obtain the plate body 111. The plate body 111 is then disposed in a mold assembly 13, and the positioning blocks 112 are formed through injection molding to engage with the engaging structures 113, respectively, as illustrated in FIG. 2.

However, the conventional base plate 11 for a keyboard has relatively high manufacturing costs due to the necessity of pre-forming the engaging structures 113 on the plate body 111. In addition, the plate body 111 made of aluminum cannot be used to produce a thinner or lighter keyboard.

### SUMMARY

Therefore, an object of the disclosure is to provide a method for manufacturing a base plate for a keyboard so as to alleviate or eliminate the aforesaid shortcomings of the conventional base plate.

According to the disclosure, a method for manufacturing a base plate for a keyboard includes the steps of:

a) providing a mold assembly including
a female mold, and
a male mold having a plurality of recesses, one of the female and male molds having a plurality of fluid passages which are fluidly communicated with the recesses;

b) preparing a composite laminate which includes a carbon fiber layer and a thermoplastic resin layer bound to the carbon fiber layer, and which is formed with a plurality of positioning holes;

c) disposing the composite laminate in the female mold, and combining the female and male molds such that the thermoplastic resin layer of the composite laminate faces the male mold, and such that the recesses of the male mold cooperate with the positioning holes of the composite laminate, respectively to define a plurality of molding zones; and

d) injecting a plastic material at a temperature higher than 150° C. through the fluid passages into the molding zones while maintaining the female mold at a temperature ranging from 90° C. to 120° C., so as to form a plurality of positioning blocks which binds to the thermoplastic resin layer and which integrates with the composite laminate to form the base plate.

### BRIEF DESCRIPTION FOR THE DRAWINGS

Other features and advantages of the disclosure will become apparent in the following detailed description of the embodiment with reference to the accompanying drawings, of which:

FIG. 1 is a partially exploded perspective view of a conventional base plate for a keyboard;

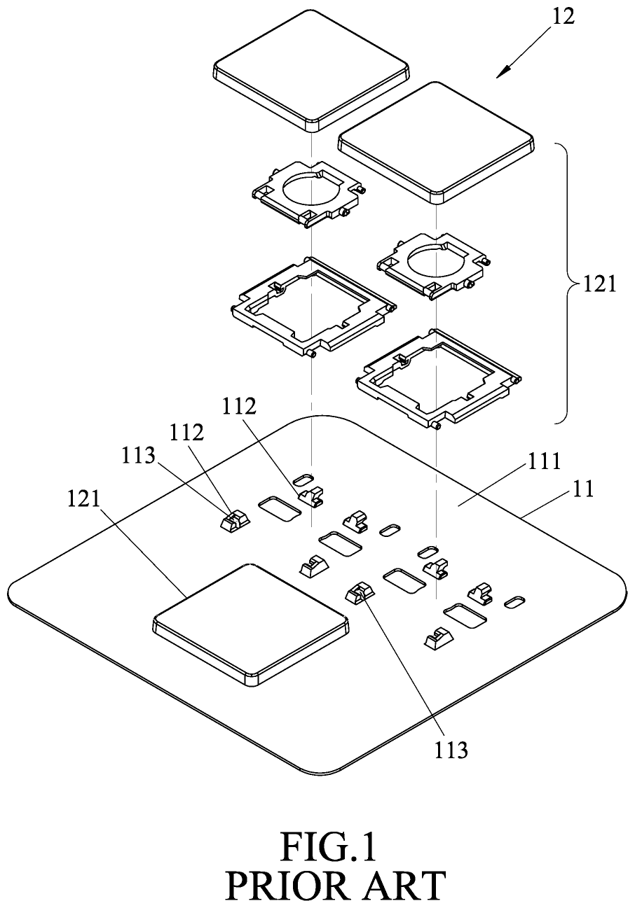

FIG. 2 is a schematic cross-sectional view illustrating an injection molding process for manufacturing the conventional base plate;

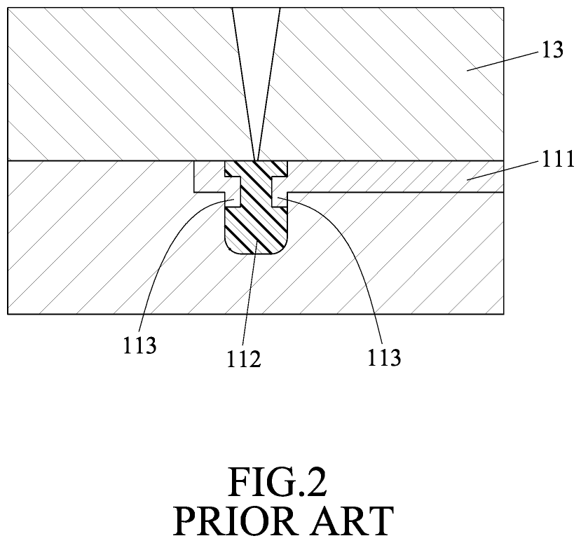

FIG. 3 is a flow diagram of an embodiment of a method for manufacturing a base plate for a keyboard according to the disclosure;

FIG. 4 is a fragmentary cross-sectional view illustrating consecutive steps of the embodiment of the method according to the disclosure; and

FIG. 5 is a perspective view of a base plate for a keyboard manufactured by the embodiment of the method according to the disclosure.

### DETAILED DESCRIPTION

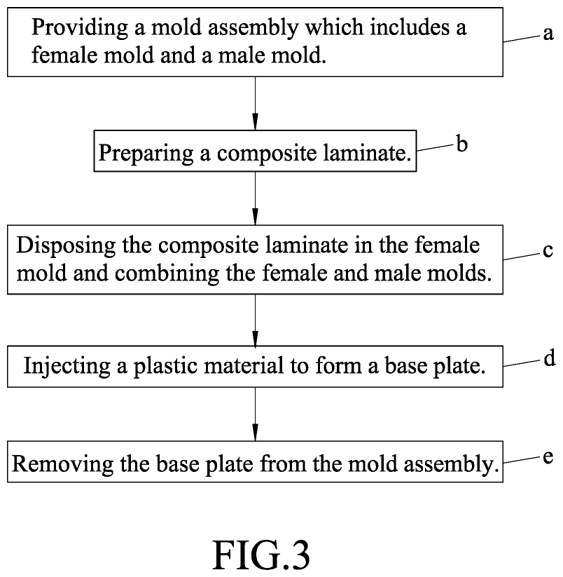

Referring to FIGS. 3, 4, and 5, an embodiment of a method for manufacturing a base plate 2′ for a keyboard includes the steps of:

a) providing a mold assembly 3 which includes a female mold 31 and a male mold 32;

b) preparing a composite laminate 2;

c) disposing the composite laminate 2 in the female mold 31 and combining the female and male molds 31, 32;

d) injecting a plastic material to form the base plate 2′; and

e) removing the base plate 2′ from the mold assembly 3.

In the mold assembly 3 provided in step a), the female mold 31 has a receiving space 311 for fittingly accommodating the composite laminate 2 therein in step c), and the male mold 32 has a plurality of recesses and a plurality of fluid passages 34 fluidly communicated with the recesses 33. Specifically, the male mold 32 has a surface 321 from which the recesses 33 are recessed inwardly.

The composite laminate 2 provided in step b) includes a carbon fiber layer 21 and a thermoplastic resin layer 22 binding to the carbon fiber layer 21, and is formed with a plurality of positioning holes 23.

In certain embodiments, step b) includes the sub-steps of:

b1) applying the thermoplastic resin layer 22 on the carbon fiber layer 21 to form the composite laminate 2, and

b2) punching the composite laminate 2 to form the positioning holes 23.

In this embodiment, the thermoplastic resin layer 22 is made of a polycarbonate resin.

In step c), the composite laminate 2 is disposed in the receiving space 311 of the female mold 31 such that the composite laminate 2 is fittingly accommodated in the receiving space 311, and the female and male molds 31, 32 are combined with each other such that the thermoplastic resin layer 22 of the composite laminate 2 faces the male mold 32, such that the surface 321 of the male mold 31 is in contact with the thermoplastic resin layer 22 of the composite laminate 2, and such that the recesses 33 of the male mold 32 cooperate with the positioning holes 23 of the composite laminate 2, respectively, to define a plurality of molding zones 35.

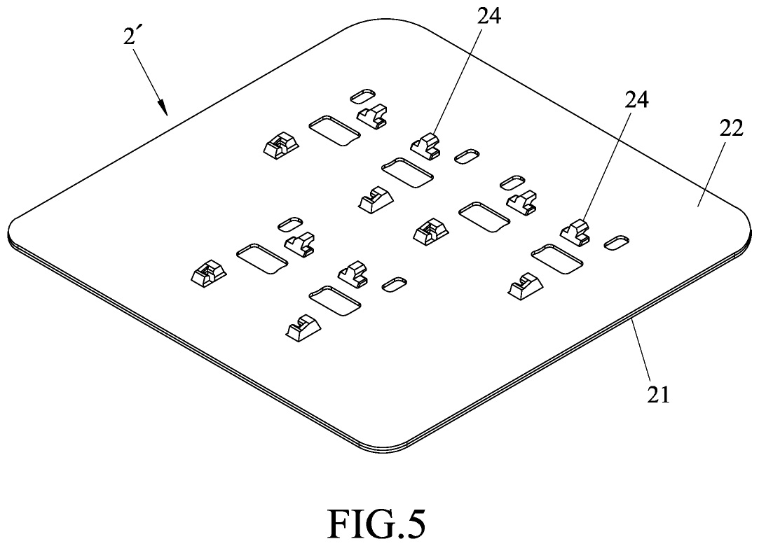

In step d), the plastic material is injected at a temperature higher than 150° C. through the fluid passages 34 into the molding zones 35 while maintaining the female mold 31 at a temperature ranging from 90° C. to 120° C., so as to form a plurality of positioning blocks 24, which binds to the thermoplastic layer 22 and which integrates with the composite laminate 2 to form the base plate 2′ as illustrated in FIG. 5.

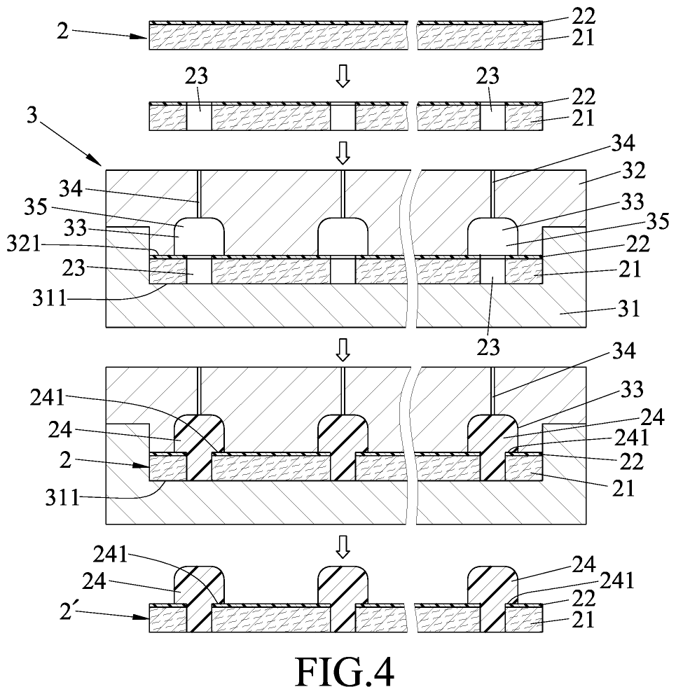

Specifically referring to FIG. 4, each of the recesses 33 has a cross-sectional area larger than that of a corresponding one of the positioning holes 23 such that each of the positioning blocks 24 formed in step d) has a binding surface 241 bound to the thermoplastic resin layer 22 of the composite laminate 2.

In certain embodiments, in step d), the plastic material is injected at a temperature ranging from 210° C. to 260° C.

It is worth noting that a resin material begins to exhibit adhesivity at temperatures higher than 140° C. Since the female mold 31 is maintained at a temperature ranging from 90° C. to 120° C. in step d), the thermoplastic resin layer 22 in the female mold 31 may also have a temperature ranging from 90° C. to 120° C. When the plastic material at a temperature higher than 150° C. is injected through the fluid passages 34 into the molding zones 35, a temperature of a part of the thermoplastic resin layer 22 in contact with the plastic material can be raised by the plastic material to above 140° C. so as to permit the thermoplastic resin layer 22 to bind to the binding surfaces 241 of the positioning blocks 24. In addition, by first raising the temperature of the thermoplastic resin layer 22 to a range from 90° C. to 120° C., embrittlement of the thermoplastic resin layer due to a big temperature gap between the thermoplastic resin layer 22 and the plastic material during the injection molding process can be prevented. Similarly, the remaining part of the thermoplastic resin layer 22 not in contact with the plastic material may be maintained at a relatively low temperature such that the molding may not be adversely affected due to the adhesivity of the remaining part of the thermoplastic resin layer 22.

Consequently, the positioning blocks 24 can bind to the thermoplastic resin layer 22 of the composite laminate 2 simultaneously while they are formed. Pre-forming of the engaging structures required in the prior art is not necessary in the method of the disclosure, and thus the costs for manufacturing the base plate 2′ can be effectively lowered.

In addition, the composite laminate 2 includes a carbon fiber layer 21 which has properties of high hardness, high strength, and light weight. Therefore, the base plate 2′ for a keyboard made with the composite laminate 2 in place of an aluminum board can be made thinner and lighter.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for manufacturing a base plate for a keyboard, comprising the steps of:
a) providing a mold assembly including
a female mold, and
a male mold having a plurality of recesses,
one of the female and male molds having a plurality of fluid passages which are fluidly communicated with the recesses;
b) preparing a composite laminate which includes a carbon fiber layer and a thermoplastic resin layer bound to the carbon fiber layer, and which is formed with a plurality of positioning holes;
c) disposing the composite laminate in the female mold, and combining the female and male molds such that the thermoplastic resin layer of the composite laminate faces the male mold, and such that the recesses of the male mold cooperate with the positioning holes of the composite laminate, respectively, to define plurality of molding zones; and
d) injecting a plastic material at a temperature higher than 150° C. through the fluid passages into the molding zones while maintaining the female mold at a temperature ranging from 90° C. to 120° C., so as to form a plurality of positioning blocks which binds to the thermoplastic resin layer and which integrates with the composite laminate to form the base plate.

2. The method according to claim 1, wherein step b) includes a sub-step of punching the composite laminate to form the positioning holes.

3. The method according to claim 2, wherein step b) further includes a sub-step of applying the thermoplastic resin layer on the carbon fiber layer to form the composite laminate.

4. The method according to claim 3, wherein the thermoplastic resin layer is made of a polycarbonate resin.

5. The method according to claim 1, further comprising, after step d), a step of removing the base plate from the mold assembly.

6. The method according to claim 1, wherein in step d), the plastic material is injected at the temperature ranging from 210° C. to 260° C.

7. The method according to claim 1, wherein the female mold has a receiving space for fittingly accommodating the composite laminate therein in step c).

8. The method according to claim 1, wherein the male mold has a surface from which the recesses are recessed inwardly and which is in contact with the thermoplastic resin layer of the composite laminate when the female and male molds are combined with each other in step c).

9. The method according to claim 1, wherein the fluid passages are formed in the male mold.

10. The method according to claim 1, wherein each of the recesses has a cross-sectional area larger than that of a corresponding one of the positioning holes such that each of the positioning blocks formed in step d) has a binding surface bound to the thermoplastic resin layer of the composite laminate.

11. The method according to claim 1, wherein in step d), a temperature of a part of the thermoplastic resin layer in contact with the plastic material is raised by the plastic material so as to permit the thermoplastic resin layer to bind to the positioning blocks.

12. The method according to claim 11, wherein in step d), the temperature of the part of the thermoplastic resin layer in contact with the plastic material is raised to above 140° C.
